(19) United States
(12) Patent Application Publication
(10) Pub. No.: US 2022/0372881 A1
(43) Pub. Date: Nov. 24, 2022

(54) ROTOR BLADE ARRANGEMENT FOR A TURBOMACHINE

(71) Applicant: MTU Aero Engines AG, Munich (DE)

(72) Inventor: Karl MAAR, Munich (DE)

(21) Appl. No.: 17/755,280

(22) PCT Filed: Oct. 14, 2020
(86) PCT No.: PCT/DE2020/000242

§ 371 Date: Apr. 26, 2022

(30) Foreign Application Priority Data
Oct. 29, 2019 (DE) 10 2019 216 646.6

(51) Int. Cl. F01D 5/20; F01D 11/12

(52) U.S. Cl. CPC F01D 5/20; F01D 11/122; F05D 2220/32; F05D 2230/60; F05D 2240/30; F05D 2240/55

(57) ABSTRACT

The present invention relates to a rotor blade arrangement for a turbomachine, with a rotor blade which has a sealing tip radially on the outside, and with a seal arrangement, wherein the seal arrangement forms a radially inwardly open cavity, in which the sealing tip is arranged, to which end the seal arrangement has a first sealing element, namely a first seal carrier with a first run-in coating, and a second sealing element, wherein the first run-in coating delimits the cavity radially on the outside, and the second sealing element delimits the cavity in an axial direction, and wherein the first and the second sealing element are assembled.

### TECHNICAL FIELD

The present invention relates to a rotor blade arrangement for a turbomachine.

### PRIOR ART

The turbomachine can, for example, be a jet engine, for example a turbofan engine. The turbomachine is divided functionally into a compressor, a combustion chamber, and a turbine. In, for example, the case of a jet engine, aspirated air is compressed by the compressor and burnt in the downstream combustion chamber with kerosene which is mixed into it. The resulting hot gas, a mixture of combustion gas and air, flows through the downstream turbine and is thus expanded. The turbine usually consists of multiple stages, each with a stator (guide vane ring) and a rotor (rotor blade ring), and the rotors are driven by the hot gas. In each stage, some of the internal energy is removed from the hot gas and converted into a movement of the respective rotor blade ring and hence the shaft.

The present subject relates to a rotor blade arrangement with a rotor blade. The rotor blade can also find general application in the field of compressors, i.e., be arranged in the compressor gas duct; application in the field of turbines is preferred, where it is thus placed in the hot gas duct.

### Representation of the Invention

The present invention is based on the technical problem of providing a particularly advantageous rotor blade arrangement.

This is achieved according to the invention with the rotor blade arrangement as claimed in claim 1. This has a sealing arrangement which forms a radially inwardly open cavity. Arranged therein is a sealing tip, also referred to as a sealing fin, of the rotor blade leaf. The sealing arrangement is composed of a first sealing element, namely a first seal carrier with a first abradable liner, and a second sealing element.

The first abradable liner delimits the cavity radially on the outside and the second sealing element delimits the cavity in an axial direction.

The sealing tip is thus surrounded in the cavity not only radially but also axially, which can reduce overflowing of the outer shroud. For example, the formation of turbulence, which otherwise interacts with the main flow in the gas duct and can cause aerodynamic losses, can thus be prevented. The arrangement of the sealing tip in the cavity can therefore, on the one hand, be advantageous for efficiency, wherein the multi-part structure of the sealing arrangement can, on the other hand, at the same time also ensure that mounting is easy. Axial ease of mounting is ensured by the fact that the second sealing element, which delimits the cavity in the axial direction and hence to a certain extent forms an axial undercut, is combined with the first sealing element.

Preferred embodiments can be found in the dependent claims and the whole disclosure, wherein a detailed distinction is not always made in the representation of the features between aspects of the device, method, and use; in each case, the disclosure is to be read as implying all claim categories. If, for example, the advantages of the rotor blade are described in a specific application, this should be read as a disclosure relating to both the correspondingly designed rotor blade and such a use.

The terms “axial/axially”, “radial/radially”, and “circumferential/circumferentially” and the associated directions (axial direction, etc) relate to the axis of rotation about which the rotor blade revolves during operation. This typically coincides with a longitudinal axis of the engine or engine module. As explained in detail below, the rotor blade arrangement can preferably find application in a turbine module, in particular in a high-speed turbine module (for example, a low-pressure turbine module). Because of the high circumferential speeds and pressure differences, the above-described interactions (overflowing/turbulence) can here be particularly significant. In addition, in the case of a high-speed turbine blade, for example the weight of the outer shroud can be reduced because of the centrifugal forces, for example it can have a cut-back design, which can further increase the risk of aerodynamic losses or turbulence in the cavity.

In general, multiple sealing tips, which are then arranged together in the cavity of the sealing arrangement, can also be arranged axially one after the other on the outer shroud. Although multiple sealing tips can be advantageous with regard to the sealing effect, according to an alternative preferred variant, just a single sealing tip can also be provided. This can, for example, be advantageous with regard to the high-speed turbine module because of the reduced centrifugal force, specifically when relatively brittle materials (for example, TiAl) are used.

A seal carrier is a carrier element, for example a curved plate which serves for fastening relative to other components. It can be supported, for example, on the outer shroud of the upstream guide vane ring and/or on the outer shroud of the downstream guide vane ring. The seal carrier carries the abradable liner and holds the latter in position, with the two fixed in place relative to each other. The abradable liner can, for example, be a cellular structure which forms cells which are open toward the cavity, for example in the form of a honeycomb structure. The abradable liner can be fastened, for example soldered, to the seal carrier but they can also both be produced integrally with each other, for example by generative manufacturing (for example, in a powder bed method).

The first seal carrier with the first abradable liner is combined with the second sealing element and they are therefore both combined as previously separately manufactured components to form the sealing arrangement. The sealing elements can be combined and fixed in place relative to each other, for example, when the engine module is assembled. Generally, in the case of the second sealing element, for example, a seal carrier in its own right, i.e., for example a curved plate without a separate abradable liner, can also axially delimit the cavity.

According to a preferred embodiment, the volume of the cavity is at most 2·(H+S)·π·R·B, preferably at most 1.6·(H+S)·π·R·B, particularly preferably at most 1.2·(H+S)·π·R·B. Possible lower limits can be situated at 0.6·(H+S)·π·R·B or 0.8·(H+S)·π·R·B. Here, R is the radius as far as an outer wall surface of the outer shroud, H is the height of the sealing tip, B is the width of the outer shroud, S is the gap width between the sealing tip and the first abradable liner, and it is the number Pi with π≈3.14159. In the case of a stepped outer shroud, the volumes of the cavity upstream and downstream of the sealing tip are calculated separately.

In a preferred embodiment, the second sealing element is also a seal carrier with an abradable liner (“second abradable liner”) and the latter delimits the cavity in the axial direction. Narrow gap dimensions can thus be achieved, also with regard to an axial offset of the rotor blade or the outer shroud at different operating points, which can correspondingly reduce the risk of overflowing.

According to a further development, the second sealing element (32), in particular its second seal carrier (32.1), is integrated into a guide vane adjacent downstream to the rotor blade (21). The second sealing element or the second seal carrier can here be a part of this guide vane and/or be formed integrally therewith. The second sealing element or the second seal carrier can also be connected directly to the guide vane adjacent downstream, in particular be fastened thereto in a non-destructively detachable or undetachable fashion.

Alternatively or additionally, the first sealing element (31), in particular its first seal carrier (31.1), can also be integrated into a guide vane adjacent upstream to the rotor blade (21). The first sealing element or the first seal carrier can here be a part of this guide vane and/or be formed integrally therewith. The first sealing element or the first seal carrier can also be connected directly to the guide vane adjacent upstream, in particular be fastened thereto in a non-destructively detachable or undetachable fashion.

Advantages in terms of assembly and disassembly can be obtained by the combination of functions in a small number of components. In addition, advantages can result for the sealing effect and hence the efficiency.

In a preferred embodiment, the second abradable liner arranged on the second seal carrier has an axial overlap with the outer shroud of the rotor blade, in at least one operating point. The axial overlap can, for example, exist at the aerodynamic design point (ADP), i.e., taking into account the axial offset which the outer shroud has at the ADP relative to the mounting position. In the region of the axial overlap, a radial spacing between the second abradable liner and the outer shroud, namely its outer wall surface facing away from the gas duct, can preferably make up no more than 3 times a radial thickness of the outer shroud. In the case of a varying outer shroud thickness, an average value formed over the outer shroud is hereby used as a basis, and the radial spacing is in contrast taken as the smallest spacing between the outer wall surface of the outer shroud and the second abradable liner. This spacing can also approach zero but, on the other hand, there can also be lower limits at, for example, 0.5 to 1 times the outer shroud thickness.

According to a preferred embodiment, the second abradable liner has in each case an axial overlap with the outer shroud of the rotor blade at all operating points, i.e., taking into account the maximum possible axial offset of the outer shroud. The overflowing of the outer shroud can thus be reduced at all operating points, i.e., the sealing effect or efficiency can be improved.

According to a preferred embodiment, the first seal carrier and/or the second seal carrier delimits a hollow space with its rear side facing away from the cavity. The seal carriers therefore extend, viewed in an axial section, relatively closely around the cavity, wherein the hollow spaces formed on the rear remain free, which can, for example, be advantageous in terms of optimizing its weight. A respective hollow space preferably has a volume which makes up at least 0.5, 1, 1.5, 2, 3, or 4 times the outer volume of the cavity (possible upper limits can be situated, for example, at 8, 6, or 5 times).

According to a preferred embodiment, the first seal carrier delimits or forms the cavity with a first axial portion and it delimits the gas duct radially on the outside with a second axial portion. Preferably, not only is the sealing tip arranged in the cavity, which is delimited in each case partly by the first abradable liner and optionally also partly by the seal carrier itself, but the whole outer shroud is accommodated therein. An inner wall surface, facing the gas duct radially, of the outer shroud can preferably be situated at the same radial height as an inner wall surface of the first seal carrier in the second axial portion. There is preferably, viewed in axial section, between the axial portions of the first seal carrier a bend point (“first bend point”) at which the seal carrier projects radially outward (from the second to the first axial portion).

According to a preferred embodiment, the second seal carrier also forms the cavity with a first axial portion, and it delimits the gas duct of the turbine machine radially on the outside with a second axial portion. The inner wall surface, facing the gas duct, of the outer shroud can in turn be situated so that it is radially flush with the inner wall surface, delimiting the gas duct, of the seal carrier in the second axial portion. Viewed in an axial section, there is preferably a bend point (“second bend point”) at which the radial offset occurs, between the axial portions of the second seal carrier.

In a preferred embodiment, viewed in axial section, a reference point of the outer shroud is situated at the most at a radial spacing, from a connecting line between the bend points of the seal carriers, which in terms of its amount makes up no more than 3 times the radial outer shroud thickness (viewed in the mounted position). Further possible upper limits are situated at no more than 2 or 1 times, and the reference point can also be situated precisely on the connecting line. The reference point is formed, by definition, by a point in the inner wall surface of the outer shroud which is situated axially centrally there.

According to a preferred embodiment, the sealing arrangement has a third abradable liner which is situated axially opposite the second sealing element. The third abradable liner correspondingly delimits the cavity in the opposite axial direction, i.e., counter to the second abradable liner. The cavity is therefore preferably delimited in both axial directions in each case by an abradable liner, in conjunction with the radial delimiting by the first abradable liner.

The first and the third abradable liner can be provided, for example, with such an axial spacing that the axial spacing from the sealing tip in the operating state in which the outer shroud is offset axially forward to the maximum extent (third abradable liner) or is offset axially rearward to the maximum extent (second abradable liner) makes up no more than 3 times the outer shroud thickness (with possible lower limits at 0.5 to 1 times).

In a preferred embodiment, the third abradable liner is arranged, together with the first abradable liner, on the first seal carrier. The first and the third abradable liner can particularly preferably be designed as a single piece with each other, i.e., be produced as an integral part. In the case of a cellular structure, the cells of both the first abradable liner and also those of the third abradable liner are radially inwardly open. Also, independently thereof, the cells of the second abradable liner can preferably be axially open, for example in the case of the turbine module axially forward, facing the rear edge of the outer shroud.

In a preferred embodiment, the third abradable liner has an axial overlap with the outer shroud at at least one operating point, preferably at all operating points (taking into account the maximum possible axial offset). Explicit reference should be made to the above description of the second abradable liner with regard to further details and specifications, in particular also relating to gap dimensions, etc. Particularly preferably, both the second and the third abradable liner in each case have an axial overlap with the outer shroud at each operating point, which ensures a particularly good sealing effect.

The invention also relates to a turbine module for a turbomachine, in particular for an aircraft engine. Particularly preferably, it is a high-speed turbine module and the rotor blade can therefore revolve, for example, with an An² of at least 2000 m²/s² (with further lower limits at 4000 m²/s² or 5000 m²/s² and upper limits at, for example, 9000 m²/s² or 6000 m²/s²). An² hereby is the area of the annular space, in particular at the outlet, multiplied by the speed in the ADP region squared.

In the turbine module, the second sealing element is preferably arranged downstream from the first seal carrier with the first abradable liner. The second abradable liner then therefore, for example, delimits the cavity axially rearward and the third abradable liner axially forward. Mounting is then preferably effected from the combustion chamber axially rearward, and the first seal carrier with the first and preferably also the third abradable liner is first mounted, and the second sealing element or the second seal carrier with the second abradable liner is then attached.

The invention moreover relates to a method for producing such a rotor blade arrangement or the turbine module, wherein the first and second sealing element are combined.

### BRIEF DESCRIPTION OF THE DRAWINGS

The invention is explained in detail below with the aid of an exemplary embodiment, wherein the individual features in the subordinate claims can be essential to the invention also in other combinations and moreover no detailed distinction is made between the different categories of claim.

In detail, in the drawings:

FIG. 1 shows schematically a turbofan engine in an axial section;

FIG. 2 shows a rotor blade arrangement according to the invention in a schematic side view in partial section;

FIG. 3 shows a further rotor blade arrangement according to the invention in a schematic side view in partial section;

FIG. 4 shows the rotor blade arrangement according to FIG. 2 as an illustration of a radial situation;

FIG. 5 shows the rotor blade arrangement according to FIG. 2 as an illustration of an axial offset at different operating points.

### PREFERRED EMBODIMENT OF THE INVENTION

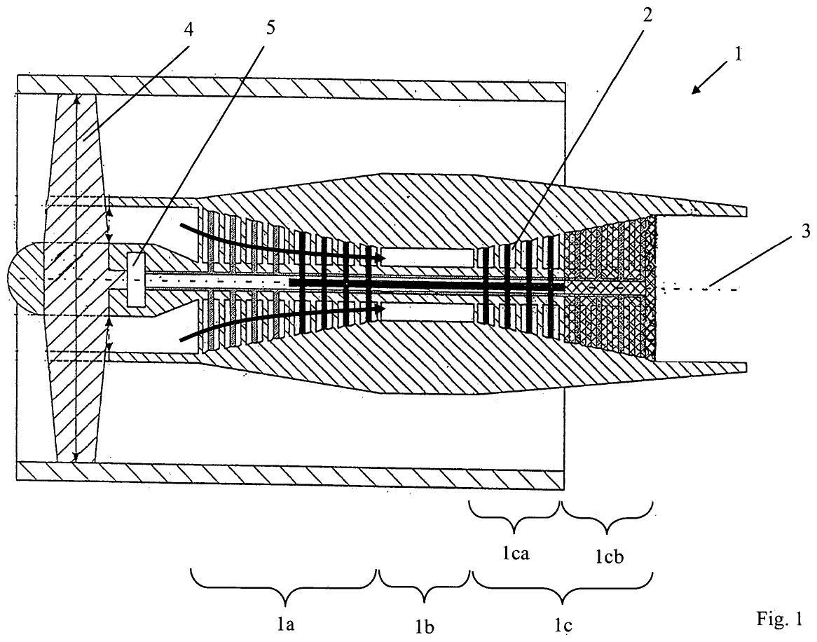

FIG. 1 shows a turbomachine 1 in a schematic view, specifically a turbofan engine. The turbomachine 1 is divided functionally into a compressor 1a, a combustion chamber 1b, and a turbine 1c, the latter having a high-pressure turbine module 1ca and a low-pressure turbine module 1cb. Both the compressor 1a and the turbine 1c here each consist of multiple stages, and each stage is composed of a guide vane ring and a rotor blade ring. In each stage, the rotor blade ring is arranged downstream from the guide vane ring, relative to the flow around the gas duct 2. During operation, the rotor blades revolve about the longitudinal axis 3. The fan 4 is coupled via a gearbox 5 and the rotor blade rings of the low-pressure turbine module 1cb revolve faster than the fan 4 during operation.

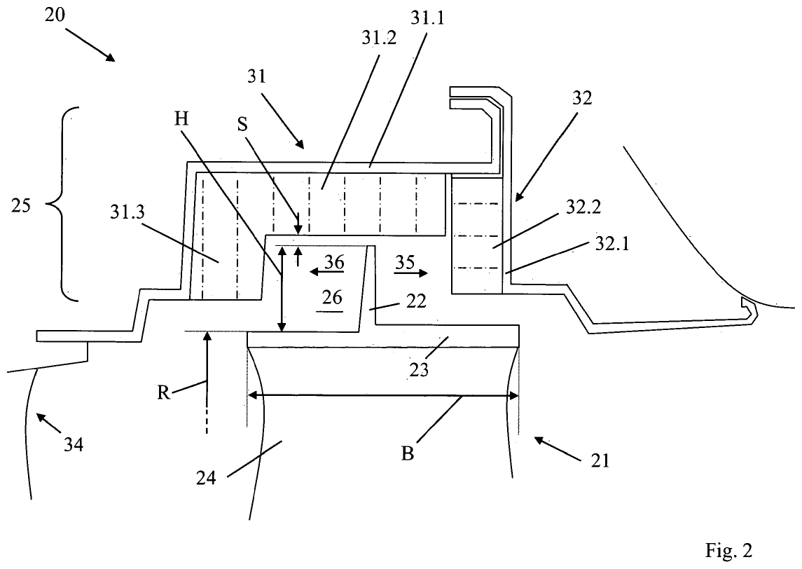

FIG. 2 shows a rotor blade arrangement 20 with a rotor blade 21 which has a sealing tip 22 on the outside radially. The sealing tip 22 is arranged on an outer shroud 23, and the rotor blade leaf 24 is situated radially inside the latter. The rotor blade arrangement 20 moreover has a sealing arrangement 25 which forms a cavity 26 in which the sealing tip 22 is arranged. The sealing tip 22 is surrounded in the cavity 26 not only radially but also axially, which ensures a good sealing effect (cf the detailed introduction to the description).

The sealing arrangement 25 here has a multi-part structure, namely is composed of a first sealing element 31 and a second sealing element 32. This ensures axial ease of mounting, and when a turbine module 1ca,cb is mounted, the first sealing element 31 can first be mounted on the upstream guide vane 34 and the rotor blade 21 can then be positioned. The second sealing element 32 is then attached and the cavity 26 hence closed axially.

The first sealing element 31 has a first seal carrier 31.1 and a first abradable liner 31.2. In the present case, the seal carrier 31.1 is a curved plate and the abradable liner 31.2 is formed by a radially inwardly open cellular structure. The first abradable liner 31.2 delimits the cavity 26 radially on the outside.

The second sealing element 32 has a second seal carrier 32.1 and a second abradable liner 32.2, in the present case an axially open cellular structure. The second abradable liner 32.2 delimits the cavity 26 in an axial direction 35. There is moreover a third abradable liner 31.3 which is here arranged as part of the first sealing element 31 on the first seal carrier 31.1 and is designed as a single piece with the first abradable liner 31.2. The third abradable liner 31.3 delimits the cavity 26 in an axial direction 36 counter to the axial direction 35.

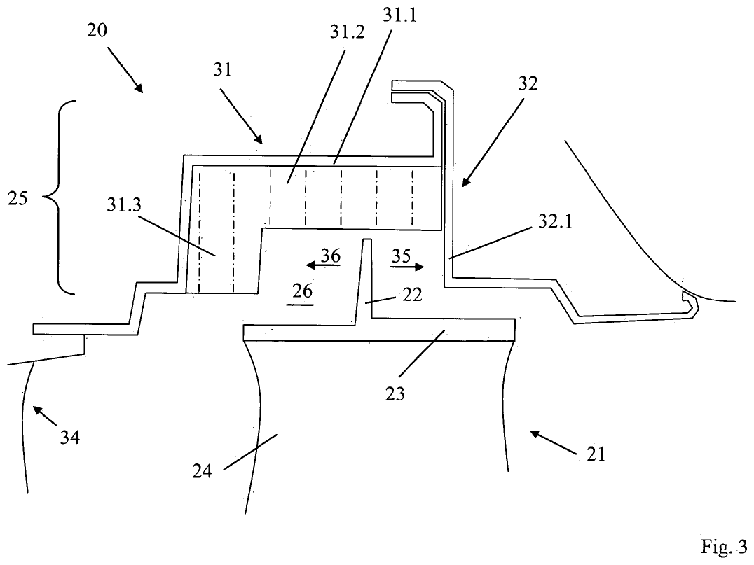

FIG. 3 shows a further rotor blade arrangement 20 according to the invention, wherein structurally identical parts of parts with the same function are provided with the same reference symbols and in this respect reference is made to the description of FIG. 2. In contrast to FIG. 2, the second sealing element 32 in this case does not have an abradable liner and instead the seal carrier 32.1 itself delimits the cavity 26 in the axial direction 35. This can represent a simplified variant in which, however, the sealing effect is also somewhat reduced.

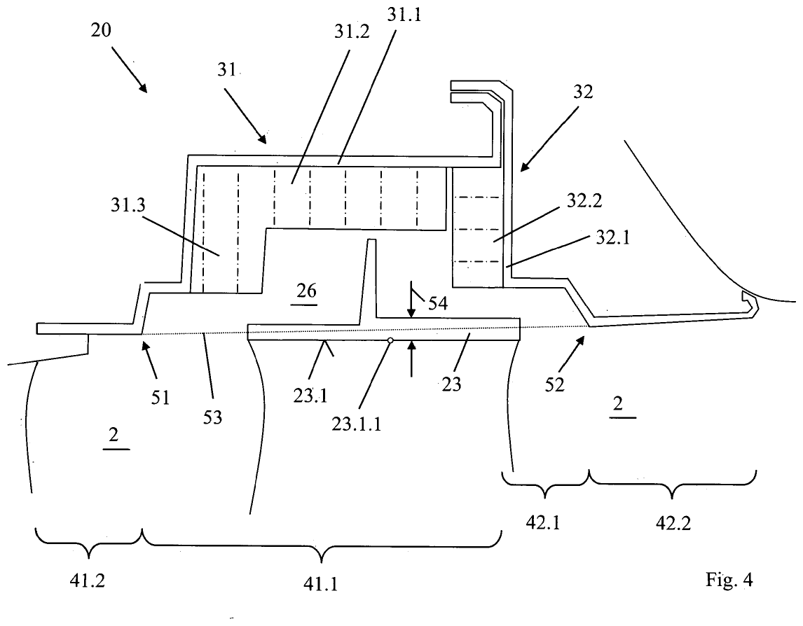

FIG. 4 relates in turn to the rotor blade arrangement 20 according to FIG. 3. It can be seen therefrom initially that a first axial portion 41.1 of the first seal carrier 31.1 forms the cavity 26 and a second axial portion 41.2 of the first seal carrier 31.1 radially delimits the gas duct 2 of the turbomachine 1. Equally, the second seal carrier 32.1 forms the cavity 26 in a first axial portion 42.1 and it delimits the gas duct 2 radially in a second axial portion 42.2. The first seal carrier 31.1 has a first bend point 51 between the first and the second axial portion 41.1,41.2 and the second seal carrier 32.1 has a first bend point 52 between the first and the second axial portion 42.1,42.2. A reference point 23.1.1 of the outer shroud 23 is situated, relative to a connecting line 53, between the bend points 51,52, spaced apart by no more than 3 times a radial thickness 54 of the outer shroud 23. The reference point 23.1.1 is situated axially centrally in an inner wall surface 23.1 of the outer shroud 23.

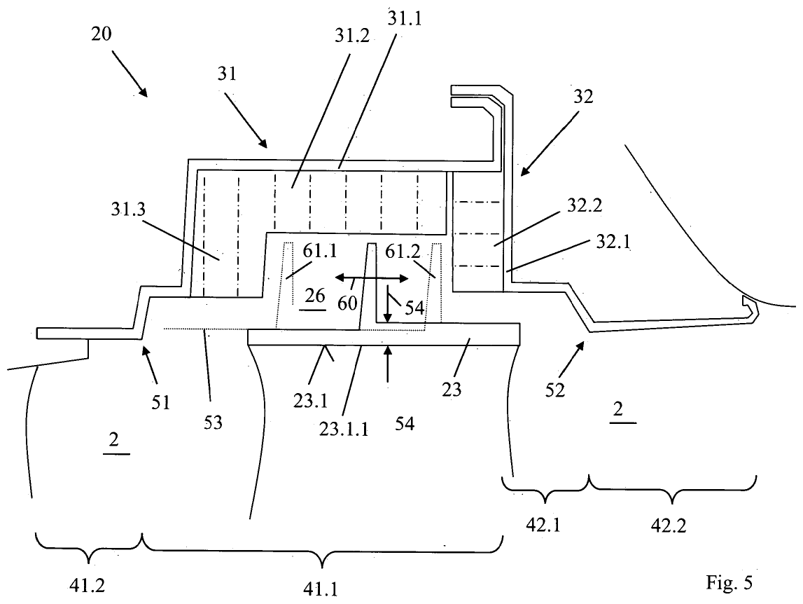

FIG. 5 illustrates that the outer shroud 23 and hence the sealing tip 22 can assume different axial positions at different operating points, and there is therefore an axial offset 60. Two axial positions 61 are illustrated here in dotted lines which mark the maximum offset forward (for 61.1) and rearward (for 61.2). The operating points are the result of different operating states of the turbomachine, in the case of the aircraft engine for example at take-off and landing or when cruising (ADP). At least the second abradable liner 32.2 or the third abradable liner 31.3 preferably in each case have an axial overlap with the outer shroud 23, and particularly preferably both have an axial overlap.

### LIST OF REFERENCE SIGNS

Turbomachine 1
Compressor 1a
Combustion chamber 1b
Turbine 1c
High-pressure turbine module 1ca
Low-pressure turbine module 1cb
Gas duct 2
Longitudinal axis 3
Fan 4
Gearbox 5
Rotor blade arrangement 20
Rotor blade 21
Sealing tip 22
Outer shroud 23
Inner wall surface 23.1
Reference point 23.1.1
Rotor blade leaf 24
Sealing arrangement 25
Cavity 26
First sealing element 31
First seal carrier 31.1
First abradable liner 31.2
Third abradable liner 31.3
Second sealing element 32
Second seal carrier 32.1
Second abradable liner 32.2
Upstream guide vane 34
Axial direction 35
Opposite axial direction 36
Axial portions (first seal carrier) 41
First axial portion 41.1
Second axial portion 41.2
Axial portions (second seal carrier) 42
First axial portion 42.1
Second axial portion 42.2
First bend point 51
Second bend point 52
Connecting line 53
Radial thickness 54
Axial offset 60
Axial positions 61
Maximum forward offset 61.1
Maximum rearward offset 61.2
Width of outer shroud B
Height of sealing tip H
Radius (longitudinal axis to outer wall surface of outer shroud) R
Gap width between sealing tip and first abradable liner S

1.-15. (canceled)

16. A rotor blade arrangement for a turbomachine, wherein the arrangement comprises a rotor blade comprising a sealing tip radially on the outside and a sealing arrangement, the sealing arrangement forming a radially inwardly open cavity in which the sealing tip is arranged, to which end the sealing arrangement comprises a first sealing element, namely a first seal carrier with a first abradable liner, and a second sealing element, the first abradable liner delimiting the cavity radially on the outside and the second sealing element delimiting the cavity in an axial direction, and wherein the first sealing element and the second sealing element are assembled.

17. The rotor blade arrangement of claim 16, wherein a volume of the cavity≤2·(H+S)·π·R·B, wherein R is a radius up to an outer wall surface of an outer shroud, H is a height of the sealing tip, B is a width of the outer shroud, and S is a gap width between the sealing tip and the first abradable liner.

18. The rotor blade arrangement of claim 17, wherein the volume of the cavity≤1.6·(H+S)·π·R·B.

19. The rotor blade arrangement of claim 17, wherein the volume of the cavity≤1.2·(H+S)·π·R·B.

20. The rotor blade arrangement of claim 16, wherein the second sealing element is a second seal carrier with a second abradable liner, the second abradable liner delimiting the cavity in an axial direction, and/or wherein the second sealing element is integrated into a guide vane adjacent downstream to the rotor blade or is connected directly to the latter, and/or the first sealing element is integrated into a guide vane adjacent upstream to the rotor blade or is connected directly to the latter.

21. The rotor blade arrangement of claim 20, wherein the second abradable liner has an axial overlap at at least one operating point with an outer shroud of the rotor blade on which the sealing tip projects radially outward.

22. The rotor blade arrangement of claim 21, wherein in a region of the axial overlap, a radial spacing between the second abradable liner and the outer shroud makes up no more than 3 times a radial thickness of the outer shroud.

23. The rotor blade arrangement of claim 21, wherein the second abradable liner has in each case an axial overlap with the outer shroud of the rotor blade at all operating points, taking into account a maximum possible axial offset of the outer shroud.

24. The rotor blade arrangement of claim 16, wherein the first seal carrier and/or a second seal carrier of the second sealing element delimits a hollow space with a rear side facing away from the cavity.

25. The rotor blade arrangement of claim 24, wherein a volume of the hollow space makes up at least 0.5 times a volume of the cavity.

26. The rotor blade arrangement of claim 16, wherein the first seal carrier forms the cavity with a first axial portion and radially delimits a gas duct of the turbomachine with a second axial portion.

27. The rotor blade arrangement of claim 26, wherein also a second seal carrier of the second sealing element forms the cavity with a first axial portion and radially delimits a gas duct of the turbomachine with a second axial portion.

28. The rotor blade arrangement of claim 27, wherein, viewed in each case in axial section, there is between axial portions of the first seal carrier a first bend point, and there is between axial portions of the second seal carrier a second bend point, wherein a reference point of an outer shroud, which is situated axially centrally in an inner wall surface, facing a gas duct, of the outer shroud, has at the most a radial spacing, from a connecting line between the first and the second bend point, which in terms of its amount makes up no more than 3 times a radial thickness of the outer shroud.

29. The rotor blade arrangement of claim 16, wherein the sealing arrangement comprises a third abradable liner which delimits the cavity in an opposite axial direction.

30. The rotor blade arrangement of claim 29, wherein the third abradable liner is arranged on the first seal carrier together with the first abradable liner.

31. The rotor blade arrangement of claim 29, wherein the third abradable liner has an axial overlap at at least one operating point with an outer shroud of the rotor blade on which the sealing tip projects radially outward.

32. A turbine module for a turbomachine, wherein the turbine module comprises the rotor blade arrangement of claim 16.

33. The turbine module of claim 32, wherein the rotor blade arrangement forms the last stage of the turbine module.

34. The turbine module of claim 32, wherein the second sealing element is arranged downstream from the first sealing element, relative to a flow around the rotor blade in a gas duct of the turbomachine.

35. A method for producing the rotor blade arrangement of claim 16, wherein the method comprises assembling the first and the second sealing element.
